(19) United States
(12) Patent Application Publication
(10) Pub. No.: US 2014/0156723 A1
(43) Pub. Date: Jun. 5, 2014

(54) Redirecting Information

(71) Applicant: Alibaba Group Holding Limited, Grand Cayman (KY)

(72) Inventors: Hangfei Huang, Hangzhou (CN); Yi Liu, Hangzhou (CN); Qi Zhong, Hangzhou (CN)

(73) Assignee: ALIBABA GROUP HOLDING LIMITED, Grand Cayman (KY)

(21) Appl. No.: 13/637,943

(22) PCT Filed: Jul. 20, 2012
(86) PCT No.: PCT/US12/47721

§ 371 Date: Sep. 27, 2012

(30) Foreign Application Priority Data
Jul. 21, 2011 (CN) 201110205607.X

(51) Int. Cl. H04L 29/08

(52) U.S. Cl. CPC H04L 67/02
USPC 709/203

(57) ABSTRACT

The present disclosure provides a method, a system, and an apparatus for redirecting information. A binding relationship between IDs of various websites may be stored in advance. When a terminal accesses a website, if websites that have been accessed by the terminal are websites related to the stored binding relationship, then at least one other website bound with the websites that have been accessed by the terminal may be selected from the binding relationship. The terminal may become a targeted terminal for the selected website(s) in receiving messages corresponding to the selected website(s). The scope of target terminals for redirection is expanded and more terminals having needs are able to receive useful messages in time. In addition, as the websites bound with each other have certain relevancy or similarity in their business, the redirection process in the present disclosure would not send messages aimlessly to cause waste of system resource.

### CROSS REFERENCE TO RELATED PATENT APPLICATIONS

This application is a national stage application of an international patent application PCT/US12/47721, filed Jul. 20, 2012, which claims foreign priority to Chinese Patent Application No. 201110205607.X filed on Jul. 21, 2011, entitled “Method and Apparatus for Redirecting Information,” which applications are hereby incorporated by reference in their entirety.

### TECHNICAL FIELD

The present disclosure relates to the field of computer information technology and, more specifically, to a method and an apparatus for redirecting information.

### BACKGROUND

Internet related business has rapidly developed as Internet technologies continue to grow. In Internet related business, to purposefully send information to terminals that visit a website, a website server may employ information direction technology to send messages to target terminals. The information direction technology refers to techniques that use a certain group of terminals as target terminals, and send messages to the target terminals only. The website may be a website composed of multiple webpages. Alternatively, the website may be a subsidiary website of a large website, or an independent website.

Frequently used information direction technologies may include the following techniques.

Geographical location based direction. The website server determines geographical areas of the terminals that visit the website, assigns terminals located in designated geographical areas as target terminals, and sends messages to the target terminals. For example, the website server may determine geographical areas of the terminals based on IP addresses of the terminals, designate the terminals located in Beijing China as the target terminals, and send messages, such as advertisements about a certain product available in Beijing China, to these target terminals.

Keyword based direction. The website server analyzes business data generated by the terminals that visit the website, assigns the terminals having one or more certain keywords in their business data as the target terminals, and sends messages to the target terminals. For example, the key word may be “smart phone.” If terminals browse and collect web pages related to smart phones when visiting the website, or purchase smart phones online, the generated business data of such terminals will includes the keyword “smart phone.” The web server then assigns such terminals as target terminals, and send messages, e.g., advertisements related to smart phones, to the targeted terminal accordingly.

People based direction. The website server determines interests of terminals based on operations taken by the terminals when they visit the website, classifies the terminals according to their interests so that each type of terminals is defined as a type of target terminals, and sends messages to a type of target terminals accordingly. For example, if a terminal frequently browses and collects webpages related to clothes, the website server may classify this terminal into a particular type of target terminals interested in clothes, and further send clothes related messages, such as advertisements of clothes, to this targeted terminal accordingly.

In addition to using the above information direction technologies, the website server may also use information redirection technology to send terminals, which have previously visited a particular website, messages corresponding to the particular website. The information redirection technology means if a terminal has visited a website, and the website is an independent website, then when the terminal visits the website again, the website sever may send the terminal messages corresponding to the website. If the website is a subsidiary website of an independent website, then when the terminal visits the website again or when the terminal visits particular webpages of the independent website, the website server may send the terminal messages corresponding to the website. The messages corresponding to the website may be information such as advertisements provided by the website.

When the website server uses the information redirection technology to send messages corresponding to the website to the terminals, if the terminals receiving such messages have previously visited and currently re-visit the website, it is very likely that the terminals are interested in the messages. The website server uses the information redirection technology to send the messages that the terminals are interested in real-time, thereby effectively increasing the visiting efficiency of the terminals.

However, the existing information redirection technology can only enable the website server to send messages corresponding to the website to the terminal when the terminal has previously visited the website and currently re-visit the website or particular webpages of the website's parent website. For a particular website, the number of terminals that have visited the website may be limited, and consequently the number of terminals that can receive the messages corresponding to the website may be limited as well. Thus terminals that may be interested in the messages, but have not previously visited the website, could not obtain the messages in real time. However, if no differentiations are made among the terminals, resulting in the messages corresponding to the website being sent to terminals as long as they are visiting the website or particular webpages of the website's parent website regardless of whether they have previously visited the website, some terminals may receive useless messages causing the website servers to consume lots of system resource to send the messages corresponding to the website to the terminals, thereby wasting lots of system resources.

### SUMMARY

The present disclosure provides a method, a system, and an apparatus for redirecting information. Under current techniques, on one hand, the number of target terminals for redirection is limited and on the other hand the information is sent without differentiation of the terminals, which leads to the waste of system resource.

The present disclosure provides a method for redirecting information. Identifications (IDs) are determined of websites that have been accessed by a terminal, which is accessing a website. One or more other websites represented by the IDs that are bound with the IDs of the websites that have been accessed by the terminal are determined based on a stored binding relationship between the IDs of the websites. At least one website is selected from the determined websites and a corresponding message is sent to the at least one website.

The present disclosure also provides an apparatus for redirecting information. The apparatus includes a website ID library, an ID determination module, a website determination module, a selection module, and a transmission module. The website ID library stores a binding relationship between the IDs of the websites. The ID determination module determines the IDs of one or more the websites, which is accessing a website, that have been accessed by a terminal. The website determination module, based on a stored binding relationship between the websites IDs, determines the websites represented by IDs that are bound with the IDs of the websites that have previously been accessed by the terminal. The selection module selects at least one website from the determined websites, and the transmission module sends a corresponding message to the at least one website.

The present techniques pre-store the binding relationship between the IDs of the websites in the website ID library. When the terminal visits a website, if the website visited by the terminal is one of the websites related to the binding relationship, at least one website that is already bound to the website already visited by the terminal is selected. The terminal may be regarded as a targeted terminal of the selected website and receive corresponding message of the selected website. Compared with conventional techniques, the present techniques enlarge the scope of the target terminal for redirection and ensure more terminals timely obtain helpful information. In addition, as the websites with the binding relationship have certain relativities or similarities in business, the redirecting under the present techniques will not blindly send messages to the terminals and thus there would be no waste of system resources.

### BRIEF DESCRIPTION OF THE DRAWINGS

To better illustrate embodiments of the present disclosure, the following is a brief introduction of figures to be used in describing the embodiments. It is apparent that the following figures only relate to some embodiments of the present disclosure. A person of ordinary skill in the art can envision other embodiments according to the figures in the present disclosure without creative efforts.

FIG. 1 illustrates a flowchart of an example method of storing the binding relationship in the website ID library in accordance with a first example embodiment of the present disclosure.

FIG. 2 illustrates a flow chart of an example method for re-directing information in accordance with a third example embodiment of the present disclosure.

FIG. 3 illustrates a flow chart of an example method for information redirection in accordance with a fourth example embodiment of the present disclosure.

FIG. 4 shows a diagram of an example apparatus for information redirection.

FIG. 5 illustrates a diagram of an example system architecture for information redirection.

### DETAILED DESCRIPTION

The present disclosure improves information redirection techniques and provides new information redirection techniques. The binding relationship between IDs of websites may be established based on requests from websites or analysis of website contents. When a terminal is accessing websites, if a particular website that the terminal has accessed is one of the websites that are involved in the binding relationship, then at least one other website bound with the particular website may be selected, and messages provided by the selected website may be sent to the terminal.

The present techniques may establish binding relationship between an ID of a website and an ID of any other website based on a request from any website or the analysis of contents of the websites, and use the terminal that has previously visited a particular website as the target terminal of other websites that have a binding relationship with the particular website. Compared with the conventional information redirection techniques, the present techniques expand the scope of target terminals for redirection, and enable more terminals having similar needs to receive useful information. In addition, as the websites with the binding relationship have certain relativities or similarities in business, the redirecting under the present techniques will not blindly send message to the terminals and thus there would be no waste of system resources.

The website may be a website composed of multiple webpages. The website may be a subsidiary website of a large website, or an independent website. For example, in a large shopping website, a seller shop composed of multiple webpages may be seen as a website. For another example, an independent shopping website may also be regarded as a website.

The ID of the website may be a unique representation of the website, such as the uniform resource locator (URL) of the website. For example, the binding relationship may be established in one of the following method. In a first exemplified method, the binding relationship between the ID of the website that initiates a binding request and the ID of the website that receives the binding request may be established based upon the binding request. In a second exemplified method, the binding relationship between websites IDs may be established based on a relativity of contents of the websites.

The following exemplified embodiments are described by reference to the figures. A first exemplified embodiment illustrates how to establish a binding relationship between the websites IDs based on the first exemplified method described above.

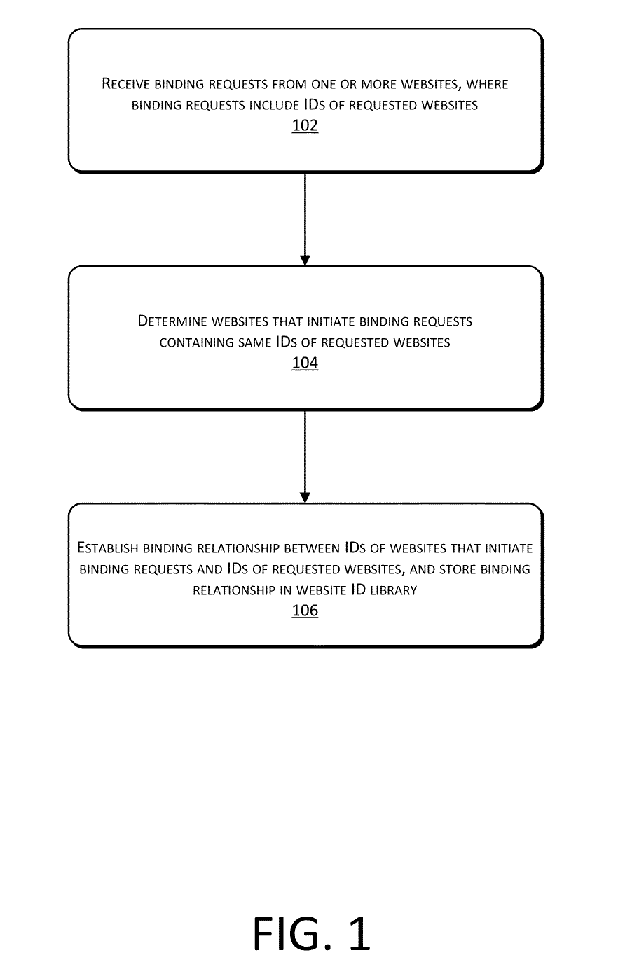

Before the information is redirected, a binding relationship between the ID of a first website that initiates the request and the ID of a second website that receives the request may be established based on the request of the first website. For example, the binding relationship may be pre-established between the ID of a first website and the IDs of other websites in which the particular website is interested based on the request of the first website. FIG. 1 illustrates a flowchart of an example method of storing a binding relationship in the website ID library in accordance with the first exemplified embodiment of the present disclosure.

At 102, a binding request from one or more websites is received. Each of the binding requests includes the IDs of requested websites. The website that sends the binding request is the website that initiates the request. The website represented by the ID contained in the request is the requested website.

As business activities of various websites may be similar or relevant to some extent, after the binding relationship is established between a first website that initiates the request and the requested second website, the terminal that has previously visited the requested website may be also interested in the information provided by the website that initiated the request. The terminal thus may become one of the target terminals of the website that initiated the request. The target terminals of the website that initiated the request are thus increased.

For example, there may be two independent video websites (website 1 and website 2), wherein the business of both websites may be online movie watching. Administrators of website 1 may submit a binding request via an information entry interface at an apparatus for information redirection or an independent server, and the binding request may contain an ID of website 2, indicating that website 1 requests to establish a binding relationship with website 2 based on their IDs.

For another example, there may be two shops (website a and website b) opened at the same shopping website, wherein both of the two websites' businesses may be to launch and sell mobile phones. A seller of website a may submit the binding request through an information entry interface at an apparatus for information redirection or an independent server, and the request may contain an ID of website b, indicating that website a would like to establish the binding relationship with website b based on their IDs.

Any website herein may act as both the website that initiates the request and the requested website.

At 104, the websites that initiate the binding requests containing the same IDs of requested websites are determined. For example, there may be multiple websites that act as the websites that initiate the requests and submit the binding requests which contain the same IDs. In other words, the multiple websites intend to establish the binding relationship with the same requested website. Thus, the websites that send requests containing the same ID may be gathered together for further operations.

At 106, a binding relationship is established between the IDs of the websites that initiate the requests and the IDs of the requested websites, and the binding relationship is stored in the website ID library. When multiple websites send binding requests to the same requested website, a multiple-to-one binding relationship may be established between the IDs of the multiple websites that initiate the requests and the requested website.

For example, there may be three shops (websites d, e, and f respectively) at the same shopping website, and the business of the three shops may be to launch and sell mobile phones. Website d and website e may each submit a binding request containing an ID of website f. A binding relationship may be separately established between the IDs of website d and website f, as well as between website d and website f, which means that a binding relationship may be established between two websites initiating the requests and a single requested website. The established binding relationship may be stored in the website ID library. Table 1 illustrates an example of the binding relationship stored in the website ID library.

TABLE 1
Table of Binding Relationship

| IDs of Websites Initiating Requests | IDs of Requested websites |
|---|---|
| ID of website d | ID of website f |
| ID of website e | |

Table 1 shows a binding relationship based on the ID of the requested website and the IDs of the websites initiating the requests bound with the ID of the requested website. In other words, table 1 intuitively shows a multiple-to-one binding relationship.

In addition to Table 1, some other forms of tables may be used to store the binding relationship. Table 2 illustrates another example table that stores the binding relationships. Table 2 intuitively shows a one-to-one corresponding relationship between IDs of the websites initiating requests and IDs of the requested websites.

TABLE 2
Table of Binding Relationship

| IDs of Websites Initiating Requests | IDs of Requested websites |
|---|---|
| ID of website d | ID of website f |
| ID of website e | ID of website f |

The examples of Table 1 and Table 2 are illustrated based on the condition that one request contains one ID. In other examples, one particular website may request to establish a binding relationship with multiple requested websites. In other words, the particular website initiates multiple binding requests. Thus, the present embodiment may also, based on the ID of the website imitating the request, use the table to represent the binding relationship with multiple requested websites, which directly represents a one-to-multiple binding relationship.

For example, there may be three shops (websites g, h, and i) at a shopping website, and website g may have submitted separate binding requests containing an ID of website h and an ID of website i. Separate binding relationships between the ID of website g and the IDs of website h and website i may be established, which means an ID of a single website initiating the request may be bound with the IDs of two requested websites. The binding relationship may be shown in Table 3 as illustrated below.

TABLE 3
Table of Binding Relationship

| IDs of Websites Initiating Requests | IDs of Requested websites |
|---|---|
| ID of website g | ID of website h |
| | ID of website i |

Although Tables 1, 2 and 3 take different forms in representing a binding relationship, the essence of the binding relationship is shown. The present embodiment is not limited to using any specific form to show the binding relationship.

The second example embodiment illustrates how to establish a binding relationship between the IDs of websites in accordance with the above described second exemplified method. The contents of the websites may be detected in advance, and compared with each other. The websites whose contents satisfy a preset relevancy requirement may be selected, and a binding relationship between IDs of the selected websites may be established and stored in the website ID library.

For example, there may be two shops (website j and website k) at a same shopping website, and the business for both website j and website k may be to launch and sell mobile phones. The contents at website j may be contents of the webpages published by website j. The contents relevancy of website j and website k may be compared to determine the contents relevancy degree between website j and website k. A threshold value of contents relevancy degree may be preset. If the content relevancy degree between website j and website k reaches the threshold value, or the content relevancy between website j and website k may have reached a predetermined requirement, therefore binding relationship between IDs of website j and website k may be established. Otherwise, the binding relationship between website j and website k may not be established.

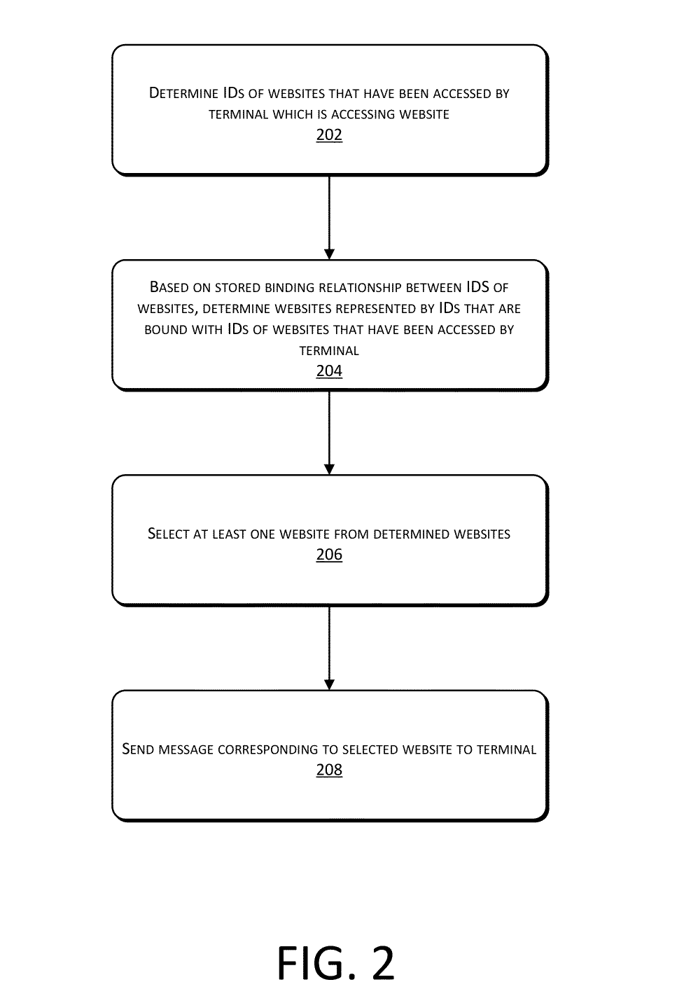

After a binding relationship between IDs of various websites is established by methods such as those in the first exemplified embodiment and the second exemplified embodiment, a third exemplified embodiment may implement the information redirection based on the established binding relationship. FIG. 2 illustrates a flow chart of an example method for re-directing information in accordance with the third exemplified embodiment of the present disclosure.

At 202, the IDs of websites that have been accessed by the terminal which is accessing a website are determined. The terminal may be any terminal that accesses the website via a network such as the Internet or a wireless network. Examples of the terminal may include personal computer (PC) or smartphone. When the terminal accesses the websites through the network, a server may record the access data of the terminal and save it in a file. The file, for example, may be one or more cookies stored on the terminal. The access data may include, for example, an ID of a website that the terminal visits, starting and ending time of the terminal's access of the website, a transaction, operation, or business carried out by the terminal when accessing the website, and other data related to the terminal's access of the website.

When the terminal is performing web accessing operations, the server may use, but is not limited to using, the following exemplified methods to determine the ID of the website that is being accessed by the terminal.

A first exemplified method involves recording the ID of the website when the terminal is directly accessing the website. A second exemplified method involves recording the ID of the website when the terminal is accessing the website through a link provided by a search engine. A third exemplified method involved recording the ID of the website when the terminal is accessing the website through a link embedded in a webpage browsed by the terminal.

The access data of the terminal may be completely or partially stored in cookies by using, for example, following exemplified methods.

A first exemplified storing method is to record the terminal's access data within a preset period of time and store them in the cookies of the terminal. The access data stored in cookies are data generated when the terminal performs accessing operations at one or more websites during the preset period of time. For example, if the preset period of time is from May 1, 2011 to May 30, 2011, the terminal's access data generated during the period of time may be stored in cookies of the terminal. When operations at 202 are performed, the terminal's access data generated during the period of time may be retrieved from the cookies to determine IDs of the one or more websites that the terminal has accessed.

A second exemplified storing method involves periodically recording the access data of the terminal and storing it in cookies of the terminal. The access data during each cycle period when the terminal accesses one or more website may be recorded. For example, the cycle period may be set to one month, the access data generated in January 2011, February 2011, etc. may be recorded periodically. When operations at 202 are performed, the terminal's access data generated during one or more cycle periods close to the current time may be retrieved from the cookies to determine IDs of the one or more websites that the terminal has accessed.

A third exemplified storing method involves storing the access data at the cookies of the terminal in real-time. The access data generated when the terminal is accessing the website are recorded in real time. When operations at 202 are performed, the terminal's access data generated before the current time may be retrieved from the cookies to determine IDs of websites that the terminal has accessed.

Any of the exemplified storing method may be preset before the binding relationship is established. For example, before the website initiates the binding request, the website initiating the binding request may already know a default storing method, and send the binding request after recognizing the default storing method.

At 204, based on a stored binding relationship between the IDs of the websites, one or more websites represented by the IDs that are bound with IDs of websites that have been accessed by the terminal are determined. The websites represented by the IDs that are bound with IDs of websites that have been accessed by the terminal may be determined by using methods in the first exemplified embodiment or methods in the second exemplified embodiment.

At 206, at least one website is selected from the websites represented by the IDs that are bound with IDs of websites that have been accessed by the terminal. At 208, messages corresponding to the selected websites are sent to the terminal.

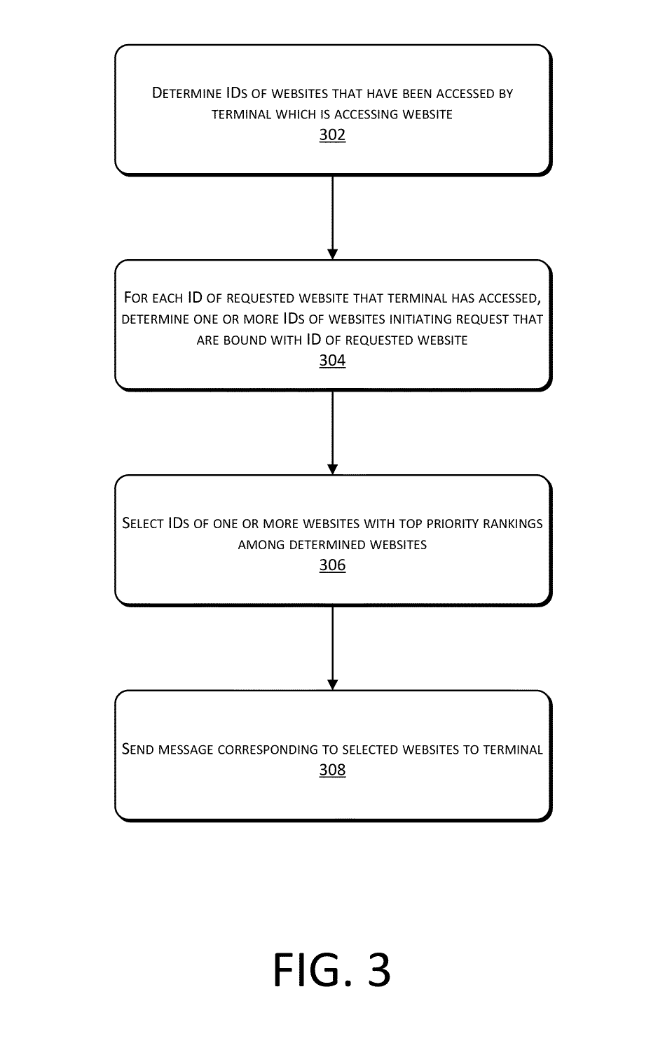

A fourth exemplified embodiment is a detailed description of the third exemplified embodiment based on methods in the first exemplified embodiment. FIG. 3 illustrates a flow chart of an exemplified method for information redirection in accordance with the fourth exemplified embodiment of the present disclosure.

At 302, the IDs of websites that have been accessed by the terminal, which is accessing a website, are determined. After the IDs of the websites that have been accessed by the terminal are determined, by any method, at 202, the IDs of requested websites among the websites that have been accessed by the terminal may be determined based on the IDs of requested websites stored in the website ID library.

For example, the IDs of websites that have been accessed by the terminal may be an ID of website 1, an ID of website 2, and an ID of website 3, where website 1 and website 2 are requested websites. Hence the IDs of requested websites that have been accessed by the terminal are the IDs of website 1 and website 2.

At 304, for each ID of the requested website that the terminal has accessed, the ID of the website initiating the request that is bound with the ID of the requested website is determined.

For example, at 302, if it is determined that the IDs of the requested websites that have been accessed by the terminal may be the IDs of website 1 and website 2, then a binding relationship stored in the website ID library may be searched in order to respectively determine the IDs of one or more websites initiating the binding requests that are bound with the ID of website 1 (assuming it is the ID of website 1_{—}1), and the IDs of one or more websites initiating the binding requests that are bound with the ID of website 2 (assuming they are IDs of website 2_{—}1, website 2_{—}2, and website 2_{—}3).

At 306, IDs of a number of N websites (N being an integer not less than 1) with top priority rankings among the websites, initiating the binding requests, that are bound by the IDs of the requested websites are selected. When N=1, it represents the website with the highest priority ranking.

If an ID of a requested website is only bound with an ID of one website that initiates the request, such that the ID of requested website 1 may be only bound with the ID of the website 1_{—}1 that initiates the request, then only website 1_{—}1 that initiates the request may be the website with the highest priority ranking corresponding to the request website 1.

If the ID of the requested website is bound with IDs of multiple websites that initiate the requests, such that the ID of requested website 2 may be bound with IDs of websites that initiate the requests 2_{—}1, website 2_{—}2, and website 2_{—}3, then one website with the highest priority ranking may be selected from the websites that initiate the requests, i.e. website 2_{—}1, website 2_{—}2, and website 2_{—}3.

For example, the priority ranking may be based on the privilege levels to send information by the websites. The higher the privilege level to send the information, the higher the priority ranking.

The privilege level to send information may be determined when the websites initiate the requests. For example, the websites when they initiate the requests may be ranked by their bids for the priority rankings. The higher the bid made by the particular website, the higher the priority ranking of the particular website.

In some other examples, in addition to the privilege level to send information, optionally the present techniques may also use a weighted sum value of parameters such as the privilege level to send information, the security level, the visit volume, etc. to determine the priority of a website. The greater the weighted sum value is, the higher the priority may be.

The security level may be determined based on the security status of the website. For example, the security level of an independent shopping website may be higher than the security level of a shop within the independent shopping website. When the two websites are both shops at the shopping website, one website with a better rating and longer registration time may be set with a higher security level while the other website with a worse ratings and shorter registration time may be set with a lower security level.

The visit volume refers to a number of times that a particular website is accessed by one or more terminals during a period of time. The more the website is accessed, the higher the visit volume may be.

After the various parameters such as the privilege level to send messages, the security level, and the visit volume are determined, each of the parameters may be assigned a weight, and a weighted sum value of the parameters may be calculated in order to generate a comprehensive evaluation of each website's priority ranking. The weight assigned to each parameter may be set based on the need of different redirection business. For example, if the information redirection operation has a high expectation on website security, then a higher weight may be assigned to the security level; if the information redirection operation has a high expectation on income, then a higher weight may be assigned to the privilege level to send messages. The present techniques may use, but are not limited to using, the above parameters in determining a website priority ranking. Other parameters representing the status of a website may also be used to determine website priority ranking as well.

At 308, messages corresponding to the selected N websites with top priority rankings are sent to the terminal.

For example, when N=1, if it is determined at 302 that the number of IDs of the requested websites that the terminal has accessed is only 1, then, regardless of the number of IDs of websites initiating requests that have been bound with the ID of the requested website, at 306 only the website having the highest priority ranking from the websites initiating the requests may be selected and the message corresponding to the website is sent to the terminal to implement redirection operation.

In another example, when N=1, if it is determined at 302 that the number of IDs of the requested websites that the terminal has accessed is M where M is any integer greater than 1, such as 2, 3, 4, etc. At 306, a website with the highest ranking from the websites initiating the requests may be determined for each of the requested website. That is, M websites with top priority rankings are selected. Then from the M websites, the website with the highest priority ranking is selected. The message corresponding to the website with the highest priority ranking is sent to the terminal.

The method for information redirection based on the second exemplified embodiment is similar to what is described in the fourth example embodiment. For brevity, no detailed description is provided herein.

The present techniques as shown from the first exemplified embodiment to the fourth exemplified embodiment explore potential target terminals for various websites, and hence the scope of target terminals for each website may be expanded. Although some terminals may not have accessed a particular website, if these terminals have accessed other websites that are relevant to the contents at the particular website, due to the relevancy or similarity between the websites, the terminals may be interested in messages from the particular website which is bound with other websites that have been accessed by the terminals. The terminals have already shown their interests in messages from such websites they have accessed. After the terminal becomes a target terminal, the terminal may receive messages provided by the websites.

For example, after a binding relationship is established in accordance with the first exemplified embodiment, if the terminal has already accessed a requested website, the websites, initiating the requests, bound with the requested website may be allowed to send message such as advertisement, products, or discounts information to the terminal. On one hand, the terminal may receive useful information from the websites that initiate the requests in time; on the other hand, as business of the websites that initiate the requests and the requested website have certain relevancy or similarity, messages are not blindly sent to any terminal. Rather, messages are sent to the terminals that have accessed the requested website, which may reduce waste of system resource arising from blindly sending messages to any terminal.

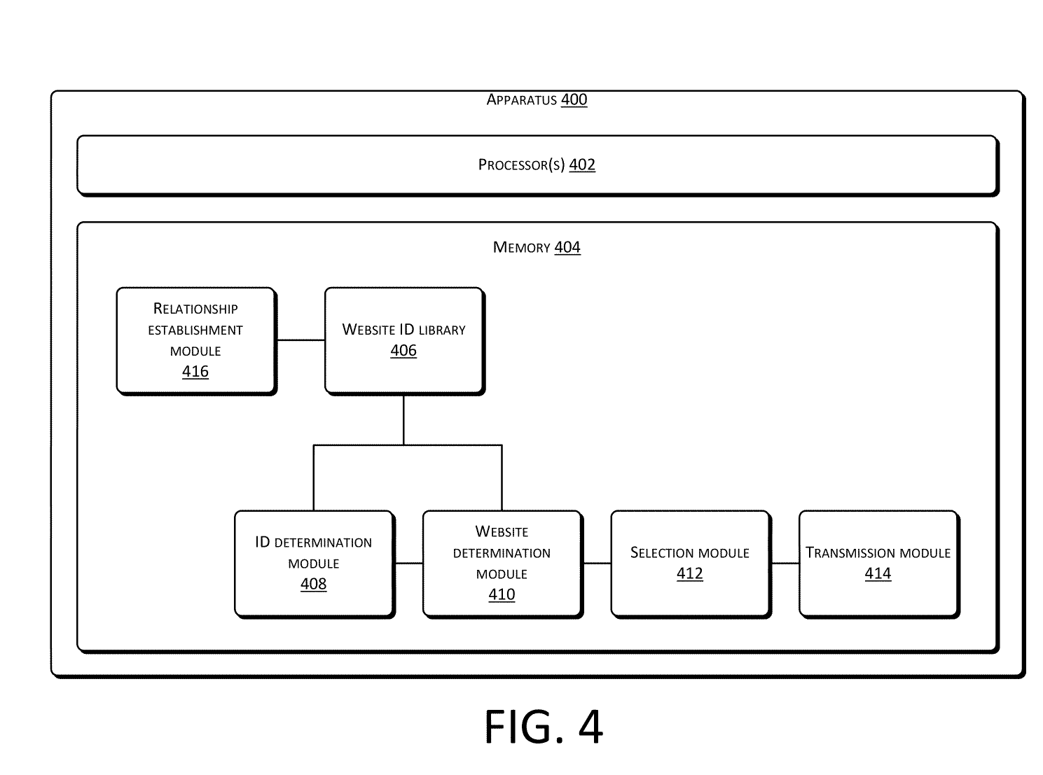

A fifth exemplified embodiment of the present disclosure provides an apparatus for information redirection. FIG. 4 shows a diagram of an example apparatus 400. The apparatus 400 may include, but is not limited to, one or more processors 402 and memory 404. The memory 404 may include computer storage media in the form of volatile memory, such as random-access memory (RAM) and/or non-volatile memory, such as read only memory (ROM) or flash RAM. The memory 404 is an example of computer storage media.

Computer storage media includes volatile and non-volatile, removable and non-removable media implemented in any method or technology for storage of information such as computer-executable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include transitory media such as modulated data signals and carrier waves.

The memory 404 may store therein program units or modules and program data. In one embodiment, the modules may include a website ID library 406, an ID determination module 408, a website determination module 410, a selection module 412, and a transmission module 414. These modules may therefore be implemented in the form of computer-executable instructions that can be executed by the one or more processors 402. In other embodiments, the modules may be implemented in firmware, hardware, software, or a combination thereof.

The website ID library 406 stores a binding relationship between website IDs. The ID determining module 408 determines IDs of websites that have been accessed by a terminal that is performing website accessing operations. The website determining module 410 determines websites represented by IDs bound with IDs of the websites that have been accessed by the terminal based on the binding relationship stored in the website ID library 406. The selection module 412 selects at least one website from the determined websites. The transmission module 414 sends to the terminal messages corresponding to the at least one websites selected by the selection module 412.

In one example, the ID determining module 408 may store access data of a terminal generated within a preset period of time in cookies of the terminal, or periodically store access data into cookies of the terminal, or store access data into cookies of the terminal in real time. The IDs of websites that have been accessed by the terminal may be determined by reading the access data stored in the cookies obtained in any of the above methods.

In another embodiment, the modules may further include a relationship establishment module 416. The relationship establishment module 416 establishes the binding relationship between IDs of websites initiating the requests and IDs of the requested websites based on the binding requests from various websites. Alternatively, the relationship establishment module 416 may establish the binding relationship between IDs of websites that meet the preset relevance threshold requirement based on relevancy of contents at the various websites.

When websites voluntarily request to establish a binding relationship, the relationship establishment module 416 may receive the binding requests from the various websites. The binding requests carry the IDs of the requested websites. The relationship establishment module 416 may determine the websites initiating the requests that include the same IDs of the requested websites, and establish the binding relationship between the IDs of the determined websites initiating the requests and the ID of the requested website.

In another example, the ID determination module 408 may, based on stored IDs of the requested websites, determine IDs of the requested websites that have been accessed by the terminal among IDs of the requested websites. The website determining module 410 may determine websites, which initiate the requests, represented by IDs bound with the ID of each requested website that has been accessed by the terminal, based on the stored binding relationship between IDs of various websites.

The selection module 412 may select N websites with the highest priority rankings from the determined websites, where N is any integer no less than 1. For example, the selection module 412 may, based on the privilege level to send messages, select N websites initiating the requests that have top N privilege level to send messages. In addition to the privilege level to send messages, the selection module 412 may also use a weighted sum value of parameters including but not limited to security level, visit volume, etc., to determine the priority rankings of various websites.

The apparatus in the fifth exemplified embodiment may be incorporated with various modules to implement operations and functions from the first exemplified embodiment or the fourth exemplified embodiment. For brevity, the details are not described herein.

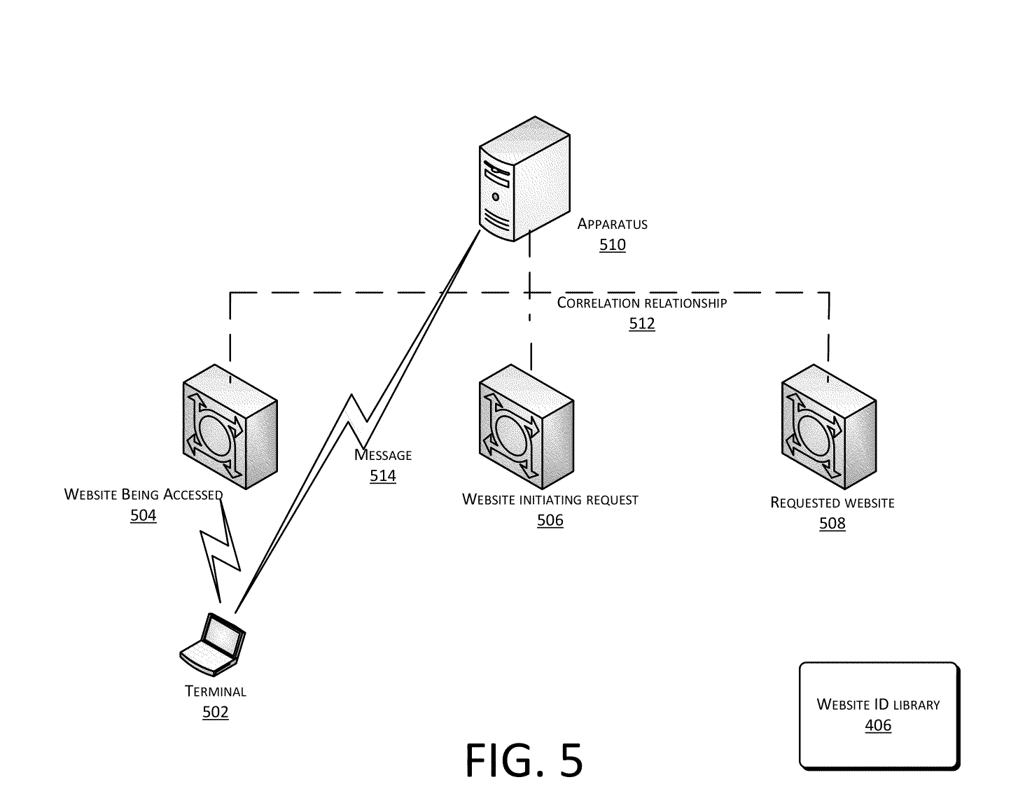

FIG. 5 illustrates a diagram of an example system architecture that uses the apparatus in the fifth exemplified embodiment to perform information redirection when a website initiates the request to establish a binding relationship. In the example of FIG. 5, a website being accessed 504 by a terminal 502, a website initiating a binding request 506, and a requested website 508 may be correlated by an apparatus 510 for information redirection. That is, the website being accessed 504 by the terminal 502, the website initiating the binding request 506, and the requested website 508 are websites having correlation relationships. For example, the correlation relationship 512 may refer to such websites being subsidiary websites of the same parent website (such as the website where the apparatus 510 for information redirection is located), or are websites registered at the same apparatus 510 for information redirection. The apparatus 510 may send messages 514 corresponding to the website initiating requests 506.

In some examples, the website being accessed 504 by the terminal 502 may be one of the requested websites or one of the websites that initiated the requests. Alternatively, the website being accessed 504 by the terminal 502 may be a website corresponding to a particular webpage of a parent website in which at least one of the requested websites and/or websites that initiated the requests are the subsidiary websites. Alternatively, the website being accessed 504 by the terminal 502 may be a website corresponding to a particular webpage of a website where the apparatus 510 for information redirection is located and at least one of the requested websites and/or websites that initiate the requests is registered at the apparatus 510.

For example, the websites that initiate the requests and the requested websites are subsidiaries or associated websites at an Internet advertisement website, and the apparatus for information redirection is also integrated in the Internet advertisement website. When a terminal accesses any websites of the Internet advertisement website, the apparatus for information redirection may perform any techniques described in the present disclosure.

As the terminals may access websites frequently, and there are a huge number of websites in the network which contain various types of contents, if methods in the present disclosure are executed when the terminal accesses any websites, then a lot of system resource would be wasted. The purpose for information redirection in the present disclosure is to provide useful messages to the terminal without sending messages aimlessly, therefore methods in the present disclosure are executed when the terminal is accessing a website that is correlated to the websites that initiate the requests or the requested websites, which may efficiently reduce the waste of system resources.

Persons skilled in the art should understand that the embodiments of the present disclosure can be methods, systems, or the programming products of computers. Therefore, the present disclosure can be implemented by hardware, software, or in combination of both. In addition, the present disclosure can be in a form of one or more computer programs containing the computer-executable codes which can be implemented in the computer-executable storage medium (including but not limited to disks, CD-ROM, optical disks, etc.).

The present disclosure is described by referring to the flow charts and/or block diagrams of the method, device (system) and computer program of the embodiments of the present disclosure. It should be understood that each flow and/or block and the combination of the flow and/or block of the flowchart and/or block diagram can be implemented by computer program instructions. These computer program instructions can be provided to the general computers, specific computers, embedded processor or other programmable data processors to generate a machine, so that a device of implementing one or more flows of the flow chart and/or one or more blocks of the block diagram can be generated through the instructions operated by a computer or other programmable data processors.

These computer program instructions can also be stored in other computer-readable storage which can instruct a computer or other programmable data processors to operate in a certain way, so that the instructions stored in the computer-readable storage generate a product containing the instruction device, wherein the instruction device implements the functions specified in one or more flows of the flow chart and/or one or more blocks of the block diagram.

These computer program instructions can also be loaded in a computer or other programmable data processors, so that the computer or other programmable data processors can operate a series of operation steps to generate the process implemented by a computer. Accordingly, the instructions operated in the computer or other programmable data processors can provide the steps for implementing the functions specified in one or more flows of the flow chart and/or one or more blocks of the block diagram.

The embodiments are merely for illustrating the present disclosure and are not intended to limit the scope of the present disclosure. It should be understood for persons in the technical field that certain modifications and improvements can be made and should be considered under the protection of the present disclosure without departing from the principles of the present disclosure.

The above descriptions of the example embodiments allow one of ordinary skill in the art to implement or use the exemplary embodiments. The present disclosure, however, is not limited to the exemplified embodiments and shall protect any technique that conforms to the widest scope of principles and features disclosed in this document.

What is claimed is:

1. A method performed by one or more processors configured with computer-executable instructions, the method comprising:
determining one or more identifications (IDs) of one or more websites that have been accessed by a terminal;
determining another one or more websites represented by IDs that are bound with the one or more IDs of the one or more websites that have been accessed by the terminal based on one or more stored binding relationships between IDs of various websites; and
selecting at least one website from the determined another one or more websites.

2. The method as recited in claim 1, further comprising sending one or more messages corresponding the selected at least one website to the terminal.

3. The method as recited in claim 1, wherein the determining one or more identifications (IDs) of one or more websites that have been accessed by the terminal comprises:
storing access data of the terminal relating to the one or more websites within a preset period of time within a file; and
retrieving the access data from the file to determine the one or more IDs of the one or more websites that have been accessed by the terminal.

4. The method as recited in claim 3, wherein:
the file is a cookie stored on the terminal; and
the access data includes an ID of a website that the terminal visits and at least one of:
a starting and an ending time of the terminal's access of the website; and
a transaction performed by the terminal when accessing the website.

5. The method as recited in claim 1, wherein the determining one or more identifications (IDs) of one or more websites that have been accessed by the terminal comprises:
storing access data of the terminal relating to the one or more websites periodically; and
retrieving the access data from the file to determine the one or more IDs of the one or more websites that have been accessed by the terminal.

6. The method as recited in claim 1, wherein the determining one or more identifications (IDs) of one or more websites that have been accessed by the terminal comprises:
storing access data of the terminal relating to the one or more websites in real-time; and
retrieving the access data from the file to determine the one or more IDs of the one or more websites that have been accessed by the terminal.

7. The method as recited in claim 1, further comprising determining the one or more stored binding relationships between IDs of the various websites.

8. The method as recited in claim 7, wherein the determining the one or more stored binding relationships between IDs of the various websites comprises binding IDs of one or more websites that initiate one or more binding requests with IDs of one or more requested websites based on the one or more binding requests.

9. The method as recited in claim 8, wherein a website that the terminal is accessing, the one or more websites that initiate one or more binding requests, and the one or more requested websites have a correlation relationship.

10. The method as recited in claim 7, wherein the determining the one or more stored binding relationships between IDs of the various websites comprises:
analyzing a relevancy of contents of the various websites;
finding two or more websites between which the relevancy meets or exceeds a threshold value;
establishing the binding relationship between the two or more websites; and
storing the binding relationship.

11. The method as recited in claim 8, wherein the determining another one or more websites represented by IDs that are bound with the one or more IDs of the one or more websites that have been accessed by the terminal comprises:
finding one or more IDs of requested websites within the one or more websites that have been accessed by the terminal based on stored IDs of multiple requested websites; and
determining other of the one or more websites represented by IDs that are bound with the found one or more IDs of the requested websites.

12. The method as recited in claim 10, wherein the determining the another one or more websites represented by IDs that are bound with the found one or more IDs of the requested websites comprises:
determining one or more websites that initiate one or more binding requests whose IDs are bound with a respective ID for the respective ID from the found one or more IDs of requested websites, based on the one or more stored binding relationships between IDs of various websites.

13. The method as recited in claim 12, wherein the determining one or more websites that initiate one or more binding requests whose IDs are bound with the respective ID comprises:
receiving the one or more binding requests from the one or more websites that initiate the binding requests, a respective binding request including an ID of a requested website;
finding one or more websites whose binding requests carry an ID of a same requested website; and
establishing the binding relationship between the respective ID of a respective requested website and the one or more found websites.

14. The method as recited in claim 1, wherein the selecting at least one website from the determined another one or more websites comprises selecting a number of N websites with top priority rankings from the another one or more website, where N is an integer not less than 1.

15. The method as recited in claim 14, wherein the priority rankings are based on privilege level of the other one or more websites to send message, the privilege level being determined by bids of the other one or more websites for priority rankings.

16. The method as recited in claim 14, wherein the priority rankings are based on a weighted sum value of multiple parameters including a privilege level to send information, a security level, and a visit volume.

17. The method as recited in claim 16, wherein a weight for the multiple parameters is set based on a requirement of information redirection.

18. One or more computer storage media having stored thereon computer-executable instructions that are executable by the one or more processors to perform actions comprising:
determining one or more identifications (IDs) of one or more websites that have been accessed by a terminal;
determining other one or more websites represented by IDs that are bound with the one or more IDs of the one or more websites that have been accessed by the terminal based on one or more stored binding relationships between IDs of various websites; and
selecting at least one website from the determined other one or more websites.

19. The one or more computer storage media as recited in claim 18, wherein the actions further comprise determining the one or more stored binding relationships between IDs of the various websites, the determining comprises binding IDs of one or more websites that initiate one or more binding requests with IDs of one or more requested websites based on the one or more binding requests.

20. An apparatus comprises:
a website ID library that stores the binding relationship between one or more identifications (IDs) of one or more websites;
an ID determining module that determines IDs of websites that have been accessed by a terminal that is accessing a website;
a website determining module that determines websites represented by IDs bound with IDs of the websites that have been accessed by the terminal based on the binding relationship stored in the website ID library;
a selection module that selects at least one website from the determined web sites; and
a transmission module that sends to the terminal messages corresponding to the at least one websites selected by the selection module.
